(19) United States
(12) Patent Application Publication
(10) Pub. No.: US 2013/0273253 A1
(43) Pub. Date: Oct. 17, 2013

(54) COATING APPARATUS AND METHOD OF MANUFACTURING COATED FILM

(71) Applicant: FUJIFILM CORPORATION, Tokyo (JP)

(72) Inventors: Satoshi KUNIYASU, Minamiashigara-shi (JP); Tamotsu SAIKAWA, Minamiashigara-shi (JP)

(73) Assignee: FUJIFILM Corporation, Tokyo (JP)

(21) Appl. No.: 13/863,765

(22) Filed: Apr. 16, 2013

(30) Foreign Application Priority Data
Apr. 17, 2012 (JP) 2012-093668

(51) Int. Cl. B05D 1/36; B05C 5/00; B05D 3/12

(52) U.S. Cl. CPC B05D 1/36; B05D 3/12; B05C 5/00
USPC 427/356; 118/123

(57) ABSTRACT

A coating apparatus includes a backup roller configured to support a web; a slot die disposed opposite to the backup roller, the slot die including a plurality of slots and being configured to eject a plurality of coating liquids from tips of the plurality of slots respectively so as to form beads of the coating liquids in a clearance between the web and a lip surface, which is a tip surface of the slot die, thereby coating the plurality of the coating liquids into multilayers simultaneously on the web being transported; and a depressurizing apparatus. Among the lip surfaces which sandwich the plurality of slots therebetween, a lip surface end portion on a downstream side in a transportation direction of the web of the lip surface with which an interface of the plurality of the coating liquids comes into contact has a curved shape with a convex cross-sectional shape.

### BACKGROUND OF THE INVENTION

1. Field of the Invention

The present invention relates to a coating apparatus and a method of manufacturing a coated film, and particularly to a coating apparatus, which coats a plurality of coating liquids into multilayers simultaneously on a surface of a web that is continuously transported using a slot die, and a method of manufacturing a coated film, in which a coated film is manufactured using the coating apparatus.

2. Description of the Related Art

A bar coater-type coating apparatus, a reverse roll coater-type coating apparatus, a gravure roll coater-type coating apparatus, a slot die coater-type coating apparatus such as an extrusion coater have been known as a coating apparatus that coats or form a coating film (coated layer) having a desired thickness on a surface of a flexible support (hereinafter also referred to as a web).

Among the above, the slot die coater-type coating apparatuses are widely used due to their capability of coating a thin film (thin layer) at a higher speed compared to other apparatuses. In recent years, the demand for liquid crystal monitors is increasing due to the widespread of personal computers and the reduction of the thickness of home-use televisions, and therefore the demand for optical films, such as polarizing films and optical compensation films, for which manufacturing of a thin film is required, is also increasing. Accordingly, the slot die coater-type coating apparatus which is capable of manufacturing a thin film as well as is capable of manufacturing a multilayered film is attracting attention.

Examples of the slot die coater-type coating apparatus capable of coating coating liquids into multilayers simultaneously include coating apparatuses described in JP1997-511681A (JP-H09-511681A) and JP2003-260400A. The above coating apparatuses eject coating liquids to a web, which is transported while supported by a backup roller, from the tips of a plurality of slots provided in a die coater respectively so as to form beads of the coating liquids in a clearance between the web and a lip surface, which is a tip surface of the die coater, thereby coating a plurality of coating liquids into multilayers simultaneously on the web being transported.

Therefore, in order to manufacture a thin film, it is necessary to decrease the thickness of a wet film coated on the web is decreased, and that is, it is necessary to narrow the clearance. When the clearance is narrowed, the backup roller and the lip surface may come into contact with each other. When the backup roller and the lip surface come into contact with each other, it may become difficult to stably carry out coating using the slot die.

### SUMMARY OF THE INVENTION

However, when the clearance is widened with respect to the wet film thickness of coating liquids coated on the web in order to avoid the contact between the backup roller and the lip surface, there is a problem in that streak defects may occur on a surface of the coating film that has been coated into multilayers simultaneously. The streak refers mainly to a linear streak at which a coating thickness is thinner than other portions in a transportation direction of the web. The streak includes a broad streak having a thick line and a sharp streak having a fine line.

In order to avoid the contact between the backup roller and the lip surface, the clearance is preferably set to three times or more the wet thickness of coating liquids coated into multilayers simultaneously on the web; however, with a slot die-type simultaneous multilayer coating apparatus of the related art, streak defect may occur.

Therefore, in actual cases, although there is a possibility that the backup roller and the lip surface may come into contact with each other, coating liquids are coated into multilayers simultaneously with the clearance narrowed to less than three times the wet thickness in order to prevent the occurrence of streak defects as much as possible.

The claimed invention has been made in consideration of the above circumstance, and provides a coating apparatus, with which the streak defects are not likely to occur during simultaneous multilayer coating, and in particular, with which coating apparatus, the coating is possible without the occurrence of streak defects even when the clearance is set to be three times or more as large as the wet thickness, and a method of manufacturing a coated film using the same.

In order to achieve the above object, according to a first aspect of the claimed invention, there is provided a coating apparatus including: a backup roller configured to support a web being transported; a slot die disposed opposite to the backup roller, the slot die including a plurality of slots and being configured to eject a plurality of coating liquids from tips of the plurality of slots respectively so as to form beads of the coating liquids in a clearance between the web and a lip surface, which is a tip surface of the slot die, thereby coating the plurality of the coating liquids into multilayers simultaneously on the web being transported; and a depressurizing apparatus configured to depressurize an upstream side of the beads of the coating liquids in a transportation direction of the web. Among the lip surfaces which sandwich the plurality of slots therebetween, a lip surface end portion on a downstream side in a transportation direction of the web of the lip surface with which an interface of the plurality of the coating liquids comes into contact has a curved shape with a convex cross-sectional shape.

The “cross-section” of “the convex cross-sectional shape” refers to a cross-section in an orthogonal direction to a longitudinal direction of the slots (i.e., die width direction). In addition, the curved shape includes a parabola represented by a quadric curve in addition to an arc shape. In addition, in a case in which two coating liquids are used, the interface of a plurality of the coating liquids comes into contact with a single lip surface, i.e., a second lip surface from the most downstream side in the transportation direction of the web. In a case in which three coating liquids are used, the interfaces come into contact with two lip surfaces, i.e., second and third lip surfaces from the most downstream side.

As mentioned above, in the structure of the slot die in the coating apparatus of the present aspect, among the lip surfaces which sandwich the plurality of slots therebetween, the lip surface end portion on a downstream side in the transportation direction of the web of the lip surface with which the interface of a plurality of the coating liquids comes into contact has a curved shape with a convesx cross-sectional shape.

Thereby, during simultaneous multilayer coating, even when a contact line, at which the interface of a plurality of the coating liquids and the lip surface come into contact with each other, moves and drops into the slot side from the lip surface end portion, since the lip surface end portion has a curved shape, the contact line is not disturbed due to the dropping.

Therefore, streak defects are not likely to occur during simultaneous multilayer coating, and, particularly, even when the clearance is set to be three times or more as large as the wet thickness, it is possible to coat coating liquids without the occurrence of streak defects.

Thereby, it is possible to carry out favorable simultaneous multilayer coating of a surface of a coated film while avoiding the contact between the backup roller and the lip surface.

According to a second aspect of the claimed invention, in the coating apparatus according to the first aspect, at least a portion of the lip surface of the slot die may have a Vickers hardness (Hv) of 500 or more, and only the lip surface end portion on the downstream side in the transportation of the web of the lip surface with which the interface of the plurality of coating liquids comes into contact have the curved shape with the convex cross-sectional shape. Meanwhile, the ‘Vickers hardness (Hv) is based on JIS Z2244.

In the present aspect, it is clarified that, in a case in which the lip surface portions are formed of a material having a Vickers hardness (Hv) of 500 or more, since it is not necessary to remove burrs, it is necessary to intentionally curve the lip surface end portion on the downstream side through polishing or the like, and other lip surface end portions are not curved. In addition, since the lip surface portions are formed of a material having a Vickers hardness (Hv) of 500 or more, the lip surface portions are less abraded during the ejection of the coating liquids. Accordingly, it is possible to stably maintain the formed curved shape.

The fact, mentioned herein, that at least the lip surface portions in the slot die are formed of a material having a Vickers hardness (Hv) or 500 or more means that a thickness portion of the tip of the slot die, in which the curved shaped is formed, is formed of a material having a Vickers hardness (Hv) of 500 or more.

According to the second aspect of the claimed invention, in the coating apparatus of the first or second aspect, the curved shape may be an arc shape having a curvature radius of 1 μm or more.

The curvature radius being 1 μm or more, the effect of suppressing streak defects enhances. Particularly, when the curved shape is an arc shape having a curvature radius of 1 μm or more, the streak defects can be reliably prevented.

According to a third aspect of the claimed invention, in the coating apparatuses of the first to third aspects, the slot die may have an underbite structure, in which a distance between the web and the lip surface located on a most downstream side in the transportation direction of the web is longer than a distance between the web and other lip surfaces.

This is because, when the lip surface on the most downstream side is formed into the underbite structure, pressure loss between the web and the lip surface decreases, and the contact line is likely to move, which makes the claimed invention particularly effective.

In order to achieve the above object, according to a fifth aspect of the claimed invention, there is provided a method of manufacturing a coated film including: a coating step of coating a plurality of coating liquids having a viscosity of 0.5 mPa·s to 40 mPa·s into multilayers simultaneously on a web using the coating apparatus according to one of the first to fourth aspects; and a drying step of drying the multilayer coating film, wherein, the plurality of coating liquids is coated in the coating step so as to satisfy a condition of bridging limit>d≧3 h, wherein d represents a distance of the clearance between the web and a lip surface with which the interface of the plurality of coating liquids on a most downstream side comes into contact among the clearances between the web and the lip surfaces with which the interface of the plurality of coating liquids comes into contact, and h represents a wet thickness of the coating liquid which constitutes a bead at a position of the clearance corresponding to the distance d, among the wet thickness of the multilayer coating film.

The “bridging limit” refers to a limit of clearance between the lip surface and the web, above which limit the coating liquids cannot be bridged between the lip surface and the web. Further, the “clearance” refers to a gap between the entire lip surface and the web. Furthermore, the viscosity is determined by measuring at a liquid temperature of 25 degrees Celsius using a B type viscometer.

According to the method of manufacturing a coated film of the aspect, since the coating apparatus according to any one of the first to fourth aspects described above is used, even when the coating liquids having a low viscosity of 0.5 mPa·s to 40 mPa·s, at which streak defects are likely to occur, are used as the plurality of the coating liquids, and simultaneous multilayer coating is carried out under a coating condition, in which streak defects are likely to occur, by increasing the clearance so that the distance d becomes three times or more the wet film thickness h, it is possible to prevent the occurrence of streak defects.

Thereby, it is possible to manufacture a coated film having favorable surface qualities on the coated film surface.

According to a sixth aspect of the claimed invention, the method of manufacturing a coated film according to the fifth aspect may further include a die preparation step of, prior to the coating step, preparing a slot die having the lip surface, which is a tip surface of the slot die, formed of a material having a Vickers hardness (Hv) of 500 or more and a lip surface end portion on a downstream side of the lip surface with which an interface of a plurality of the coating liquids comes into contact, in a transportation direction of the web polished into a curved shape with a convex cross-sectional shape.

This means that, in a case in which the lip surface portion is formed of a material having a Vickers hardness (Hv) of 500 or more, the cross-sectional shape of the lip surface end portion is a square shape (the curvature radius is zero), and the slot die in which the lip surface end portion is curved through, for example, the burr removal or the like by accident is not included.

According to a seventh aspect of the claimed invention, in the method of manufacturing a coated film according to the sixth aspect, in the die preparation step, the lip surface may be polished so that a curvature radius of the lip surface end portion is 1 μm or more.

As the curvature radius of the arc shape of the lip surface end portion is increased to 1 μm or more, the effect of suppressing streak defects also enhances. In addition, in order to reliably prevent streak defects, the curvature radius may be set to 1 μm or more.

According to an eighth aspect of the claimed invention, in the method of manufacturing a coated film according to the seventh aspect, in the die preparation step, only the lip surface with which the interface of a plurality of the coating liquids comes into contact, may be polished.

As described above, this means that, in a case in which the lip surface portions are formed of a material having a Vickers hardness (Hv) of 500 or more, it is necessary to intentionally curve the lip surface end portion through polishing or the like, and other lip surface end portions are not curved.

According to the coating apparatus and the method of manufacturing a coated film of the claimed invention, the streak defect is not likely to occur during simultaneous multilayer coating, and, particularly, it is possible to coat coating liquids without the streak defect even when the clearance is set to be three times or more as large as the wet thickness. Thereby, it is possible to coat a favorable multilayer simultaneously of the surface of a coated film while avoiding the contact between the backup roller and the lip surface.

Thereby, even in a case in which the thickness of a wet film coated on the web is thin, it is possible to manufacture a coated film having favorable surface qualities on the coated film surface without the contact between the backup roller and the lip surface.

### BRIEF DESCRIPTION OF THE DRAWINGS

FIG. 1 is an overall configuration view of a coating apparatus of an embodiment of the claimed invention.

FIG. 2 is an enlarged view of a lip surface portion of the coating apparatus.

FIGS. 3A and 3B are explanatory views explaining actions of a coating apparatus of the related art.

FIGS. 4A and 4B are schematic views illustrating sharp streaks having an equal pitch shape and broad streaks having an equal pitch shape.

FIGS. 5A and 5B are explanatory views explaining actions of the coating apparatus of the embodiment of the claimed invention.

FIG. 6 is an explanatory view of an underbite structure in a coating apparatus of another embodiment of the claimed invention.

FIG. 7 is an explanatory view of a coating apparatus of the other embodiment of the claimed invention, in which three liquids are coated into multilayers simultaneously.

FIG. 8 is a table describing conditions and results of examples and comparative examples.

### DESCRIPTION OF THE PREFERRED EMBODIMENTS

Hereinafter, embodiments of the coating apparatus and the method of manufacturing a coated film of embodiments of the claimed invention will be described in detail with reference to the accompanying drawings.

In the drawings, portions indicated by the same reference sign are the same element having the same function. In addition, in the present specification, in a case in which a numeric range is expressed using “to”, the numeric values of the upper limit and the lower limit, which are indicated by “to” are also included in the numeric range. In addition, the description of upstream, downstream, upstream side and downstream side all refer to upstream (side) and downstream (side) with respect to the transportation direction of the web.

[The Configuration of the Coating Apparatus]

A coating apparatus of an embodiment of the claimed invention is an apparatus that coats a plurality of coating liquids into multilayers simultaneously on a surface of a web (also called a support or a film), which is supported by a backup roller and continuously transported, using an extrusion-type slot die.

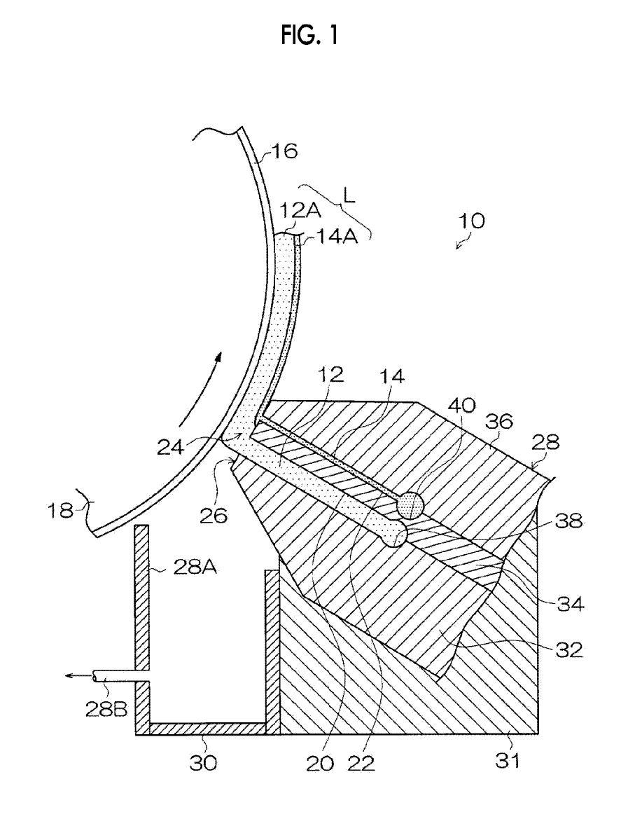

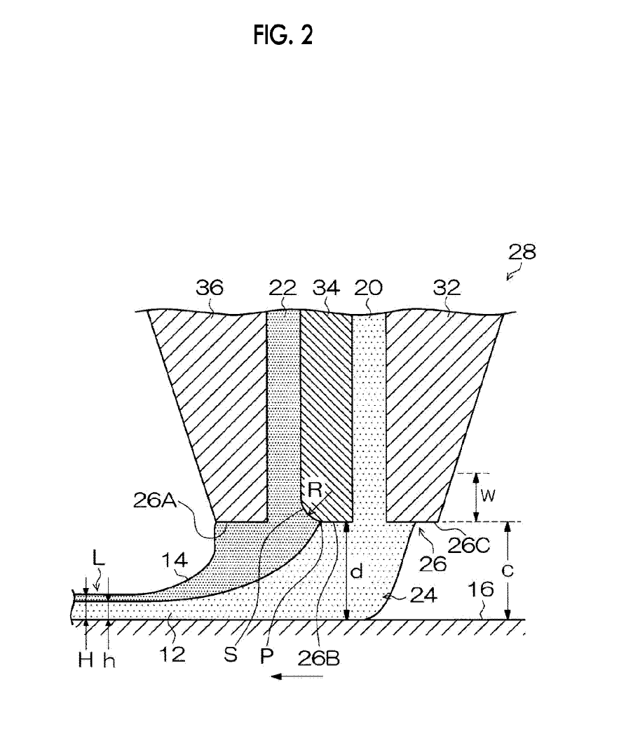

FIG. 1 is a cross-sectional view illustrating an example of a coating apparatus 10 of the embodiment of the claimed invention. FIG. 2 is a partially enlarged view of the vicinity of a lip surface of the coating apparatus 10, in which a depressurizing apparatus is not shown.

The coating apparatus 10 will be described using an example in which two types of coating liquid 12 (bottom layer) and coating liquid 14 (top layer) are coated into multilayers simultaneously. Herein, the bottom layer refers to a layer in contact with a web 16.

As illustrated in FIGS. 1 and 2, the coating apparatus 10 of the embodiment is configured of a backup roller 18, a slot die 28 disposed opposite to the backup roller 18, and a depressurizing apparatus 30. The backup roller 18 rotates while supporting the web 16 being transported. The slot die 28 ejects the two types of the coating liquids 12 and 14 respectively from the tips of two slots 20 and 22 so as to form a bead 24 of the coating liquids in a clearance C (refer to FIG. 2) between a lip surface 26, which is a tip surface of the slot die, and the web 16, thereby coating the coating liquids 12 and 14 into multilayers simultaneously on the web 16 being transported in an arrow direction. The depressurizing apparatus 30 depressurizes an upstream side of the bead 24 of the coating liquids in the transportation direction of the web. In addition, the slot die 28 is mounted on a mounting base 31.

In addition, the depressurizing apparatus 30 is supported by a side surface of the above mounting base 31 on a backup roller 18 side. Specifically, an upstream side of the slot die 28 is covered with a cover 28A, and air inside the cover 28A is suctioned through an air pipe 28B using a vacuum pump (not shown), thereby depressurizing an area inside the cover 28A. Thereby, a pulling force and a force exerted by the coating liquids due to the transportation of the web are balanced on the upstream side of the bead 24, whereby the bead 24 stabilizes.

In addition, the slot die 28 includes a plurality of blocks 32, 34 and 36.

In addition, the slots 20 and 22 extending to the lip surface 26, which is a tip surface of the slot die, from pockets 38 and 40 and pockets 38 and 40 for storing the coating liquids 12 and 14 respectively are formed in the slot die 28 by combining a plurality of the blocks 32, 34 and 36.

As illustrated in FIG. 1, the pockets 38 and 40 may be configured to have a substantially circular or semicircular cross-sectional shape. The pockets 38 and 40 are liquid reservoir spaces for the coating liquids 12 and 14, which have cross-sectional shapes extending in the width direction (the front and back direction of the paper of FIG. 1) of the slot die 28,

FIG. 1 illustrates three blocks 32, 34 and 36, two pockets 38 and 40, and two slots 20 and 22, but the number of the blocks is not limited to three, and the numbers of the pockets and the slots are also not limited to two. The necessary number of the blocks and the necessary numbers of the pockets and the slots may be formed depending on the kind and number of necessary coated film.

The slot die 28 and the backup roller 18 are located so that the clearance C has a predetermined distance between the lip surface 26, which is the tip surface of the slot die 28, and the web 16 supported by the backup roller 18.

As illustrated in FIG. 2, in the lip surface 26, a lip surface on the most downstream side in the transportation direction of the web 16 (the arrow direction) is called a downstream lip surface 26A, a lip surface adjacent to the downstream lip surface 26A is called an adjacent lip surface 26B, and a lip surface on the most upstream side is called a upstream lip surface 26C. In other words, the tip surface of the block 36 is called the downstream lip surface 26A, the tip surface of the block 34 is called the adjacent lip surface 26B, and the tip surface of the block 32 is called the upstream lip surface 26C.

As illustrated in FIG. 2, among the downstream lip surface 26A and the adjacent lip surface 26B, which sandwich the slot 22 located on the downstream side therebetween, a lip surface end portion S on the downstream side of the adjacent lip surface 26B is formed into a curved shape having a convex cross-sectional shape.

FIG. 2 illustrates an arc shape having a curvature radius R as the curved shape, but examples of the curved shape also include a parabola shape represented by a quadric curve or the like in addition to the arc shape.

The curvature radius R of the arc shape is preferably, for example, 1 μm or more from the viewpoint of suppressing streak defects. Particularly, the curvature radius R of the arc shape is preferably 10 μm or more, more preferably 30 μm or more, and still more preferably 40 μm or more. Although the upper limit of the curvature radius R is not described, it is preferably equal to or less than the width of the adjacent lip surface 26B, that is, the thickness of the block 34. The width of the adjacent lip surface 26B is preferably in a range of 50 μm to 150 μm.

In addition, at least lip surface portions of the blocks 32, 34 and 36 that configure the slot die 28, which are represented by W, are preferably formed of a material having a Vickers hardness (Hv) of 500 or more so that the curved shape formed in the lip surface end portion on the downstream side of the adjacent lip surface 26B is formed of a material having a Vickers hardness (Hv) of 500 or more. Examples of the material having a Vickers hardness (Hv) of 500 or more, which may be preferably used, include silicon carbide, tungsten carbide and the like.

In addition, in the lip surface portion formed of the material having a Vickers hardness (Hv) of 500 or more, the lip surface end portion S is formed into a curved shape by carrying out polishing or the like only on the lip surface end portion S on the downstream side of the adjacent lip surface 26B. In other words, it is preferable that only the lip surface end portion S on the downstream side of the adjacent lip surface 26B be formed into a curved shape having a convex cross-sectional shape, while, in other lip surface end portions, the cross-sectional surfaces formed of the material having a Vickers hardness (Hv) of 500 or more be formed into a square shape (the curvature radius is zero). In a case in which the lip surface portion is formed of a material having a Vickers hardness (Hv) of 500 or more, the lip surface end portion on the downstream side of the square adjacent lip surface 26B is polished so that the cross-section formed of the material having a Vickers hardness (Hv) of 500 or more has a curvature radius of 1 μm or more. As the curvature radius is increased so as to be 1 μm or more, the effect of suppressing the streak defect also enhances, and the curvature radius is preferably 10 μm or more.

[The Method of Manufacturing a Coated Film]

Next, a method of manufacturing a coated film using the coating apparatus 10 configured as described above will be described.

(Die Preparation Step)

First, a slot die 26 is prepared, in which the lip surface portion, which is the tip surface of the slot die 28, is formed of a material having a Vickers hardness (Hv) of 500 or more, and the lip surface end portion S on the downstream side of the adjacent lip surface 26B, with which the interface of the coating liquids 12 and 14 comes into contact, in the transportation direction of the web, is polished into a curved shape having a convex cross-sectional shape.

(Coating Step)

Next, the two types of coating liquids 12 and 14 are coated into multilayers simultaneously using the coating apparatus 10 having the slot die 28 prepared above, and a multilayer coating film L is formed on the web 16 surface.

In such a coating step, the two types of the coating liquids 12 and 14 being used have a viscosity of 0.5 mPa·s to 40 mPa·s.

In addition, the coating is carried out under a coating condition in which bridging limit>d≧3 h is satisfied, wherein the distance between the web 16 and the lip surface on the upstream side of the slot 22 on the most downstream side in the transportation direction of the web 16, that is, the adjacent lip surface 26B is represented by d, and the wet thickness of the coating liquid 12 that configures a bead portion at a position of the clearance which corresponds to the distance d, among the wet film thickness H of the multilayer coating film L, which is formed on the web 16, is represented by h.

As such, since the lip surface end portion S on the downstream side of the adjacent lip surface 26B is formed into a curved shape having a convex cross-sectional shape as the structure of the slot die 28 in the coating apparatus 10, even when the coating liquids 12 and 14 having a low viscosity, at which streak defects are likely to occur, are used, and simultaneous multilayer coating is carried out under a coating condition, in which streak defects are likely to occur, by increasing the clearance C so that the distance d becomes three times or more the wet film thickness h, it is possible to prevent the occurrence of streak defects.

Therefore, it is possible to form the multilayer coating film L having favorable surface qualities while avoiding the contact between the backup roller 18 and the lip surface 26 in the slot die 28.

Next, a mechanism, in which the streak defects do not occur by forming the lip surface end portion S on the downstream side of the adjacent lip surface 26B into a curved shape having a convex cross-sectional shape even when the coating liquids 12 and 14 having a low viscosity are used, and the distance d is widened so as to be three times or more the wet film thickness h and the crosslinking limit or less, will be considered.

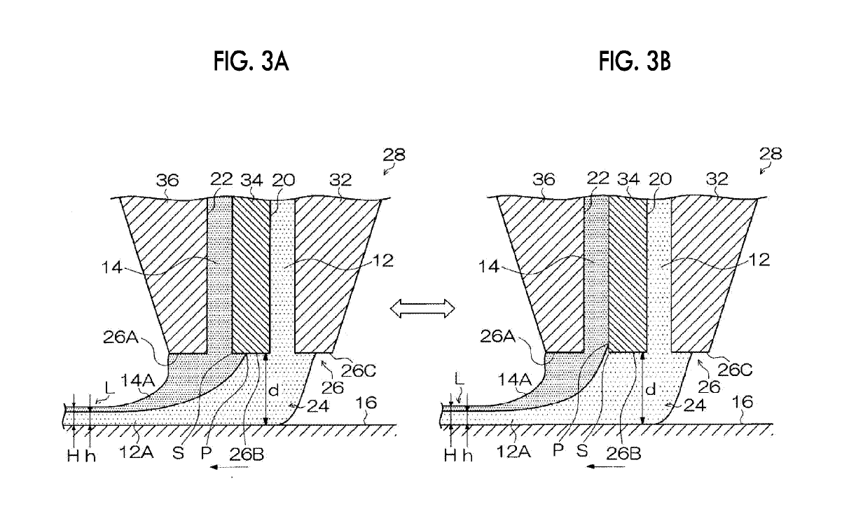

FIGS. 3A and 3B illustrate a slot die of the related art, which is a case in which the lip surface end portion S on the downstream side of the adjacent lip surface 26B has a square shape, that is, has a curvature radius e of zero.

As illustrated in FIGS. 3A and 3B, a contact line P (a line extending in the front and back direction of the paper of FIGS. 3A and 3B) at which the adjacent lip surface 26B comes into contact with a liquid-liquid interface formed by coating the two types of coating liquids 12 and 14 into multilayers on the web 16 simultaneously moves on the adjacent lip surface 26B in the transportation direction of the web. The contact line P may be more likely to move as the viscosities of the coating liquids 12 and 14 being used decrease. In addition, as the clearance C of the multilayer coating film L with respect to the wet film thickness H increases, pressure loss decreases, and the fraction resistance of the lip surface 26 or the web 16 with respect to the coating liquid bead 24 decreases, and therefore the contact line P is likely to move.

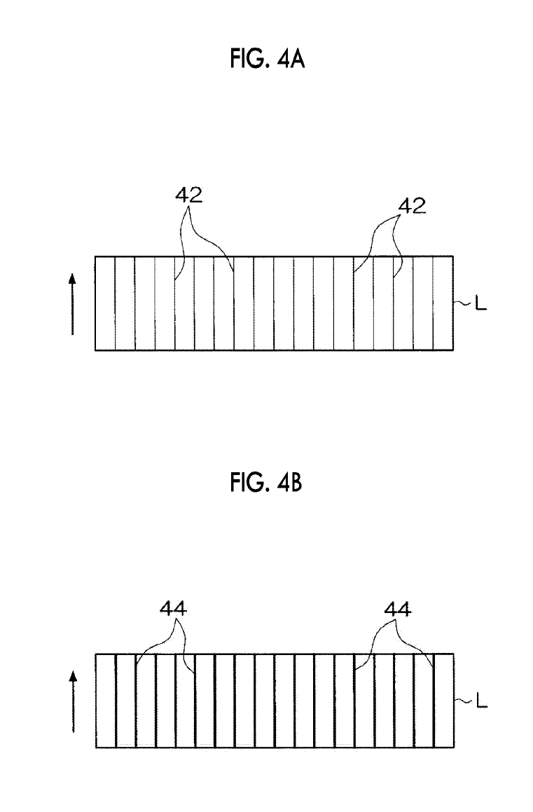

Therefore, as in the slot die of the related art, if the lip surface end portion S on the downstream side of the adjacent lip surface 26B has a square shape, when the contact line P moves and drops into the slot 22 side from the lip surface end portion S, the contact line drops sharply from the horizontal direction to the vertical direction. This sharp drop disturbs the contact line P. As a result, the streak defects are considered to occur on the surface of the multilayer coating film L as illustrated in FIG. 4 due to the sharp disturbance of the contact line P.

FIG. 4A is a schematic view illustrating fine sharp streaks 42 having an equal pitch shape formed on the surface of the multilayer coating film L. As illustrated in FIG. 4A, the sharp streaks 42 refer to the occurrence of a film thickness variation of 1 mm or less, which is parallel to the transportation direction (arrow direction) of the web 16, at equal intervals in the width direction of the web 16. In addition, FIG. 4B is a schematic view illustrating large broad streaks 44 having an equal pitch shape. As illustrated in FIG. 4B, the broad streaks refer to the occurrence of a film thickness variation of 1 mm or more, which is parallel to the transportation direction (arrow direction) of the web 16, at equal intervals in the width direction of the web 16.

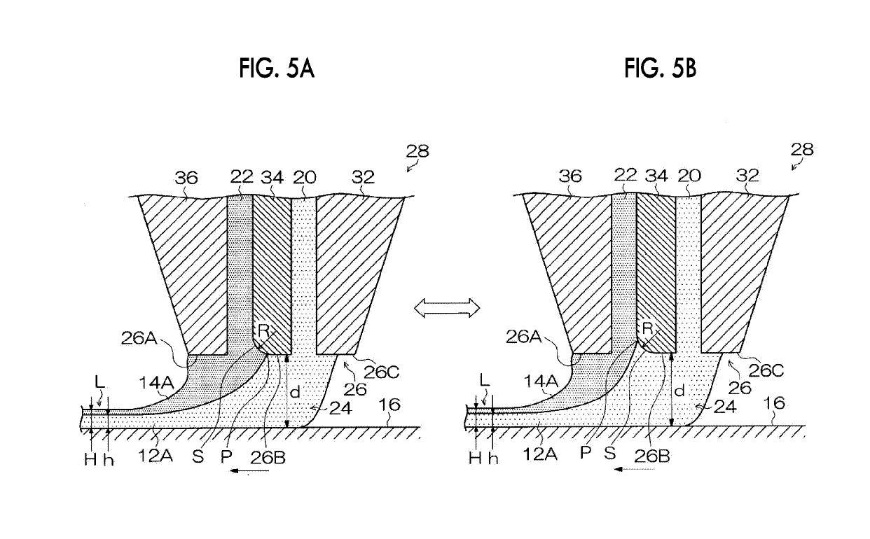

In contrast to the above, in the slot die 28 of the embodiment of the claimed invention, even when the contact line P moves and drops into the slot 22 side from the lip surface end portion S as illustrated in FIGS. 5A and 5B, since the lip surface end portion S on the downstream side of the adjacent lip surface 26B has a curved shape, the contact line does not drop sharply as it does in the slot die of the related art. Thereby, it is considered that the contact line P is not disturbed, and therefore the streak defects does not occur.

Therefore, it is possible to form the multilayer coating film L having favorable surface qualities while avoiding the contact between the backup roller 18 and the lip surface 26 in the slot die 28.

The multilayer coating film L formed on the web 16 surface in the coating step is dried in a drying step. A drying method used in the drying step is not particularly limited, and hot air drying and the like may be used.

[Another Embodiment of the Slot Die]

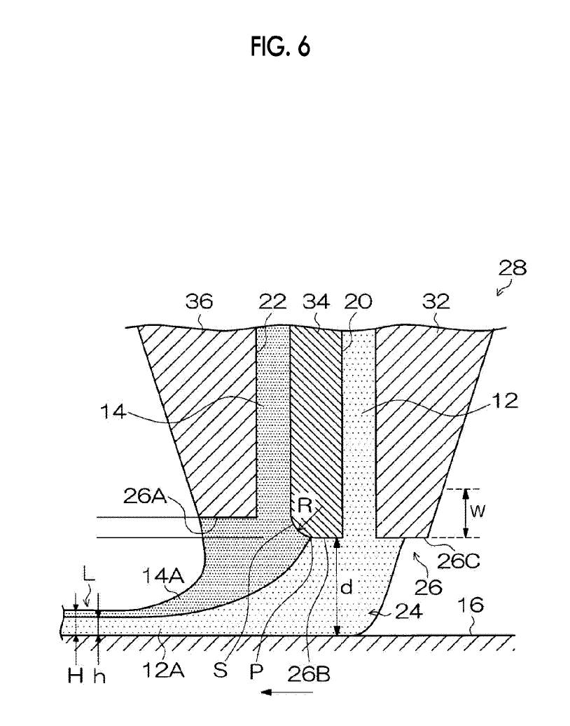

FIG. 6 is a modified example of the slot die 28 coating two layers simultaneously, which is illustrated in FIGS. 1 and 2, and is a case in which the downstream lip surface 26A has the underbite structure.

The underbite structure refers to a structure in which the downstream lip surface 26A located on the most downstream side in the transportation direction of the web 16 is located farther away from the web 16 than the adjacent lip surface 26B.

In the case of the slot die 28 having such a underbite structure, the distance between the downstream lip surface 26A and the web 16 becomes larger than a case in which the slot die does not have the underbite structure. Thereby, the pressure loss applied to the coating liquid bead 24 further decreases, and the fraction resistance with respect to the lip surface 26 or the web 16 surface further decreases. As a result, the contact line P, at which the liquid-liquid interface between the coating liquids 12 and 14 and the adjacent surface 26B come into contact with each other, becomes more likely to move, and the streak defects become likely to occur.

Therefore, the formation of a curved shape at the lip surface end portion S on the downstream side of the adjacent lip surface 26B is as effective as the slot die 28 having the underbite structure for the prevention of streak defects.

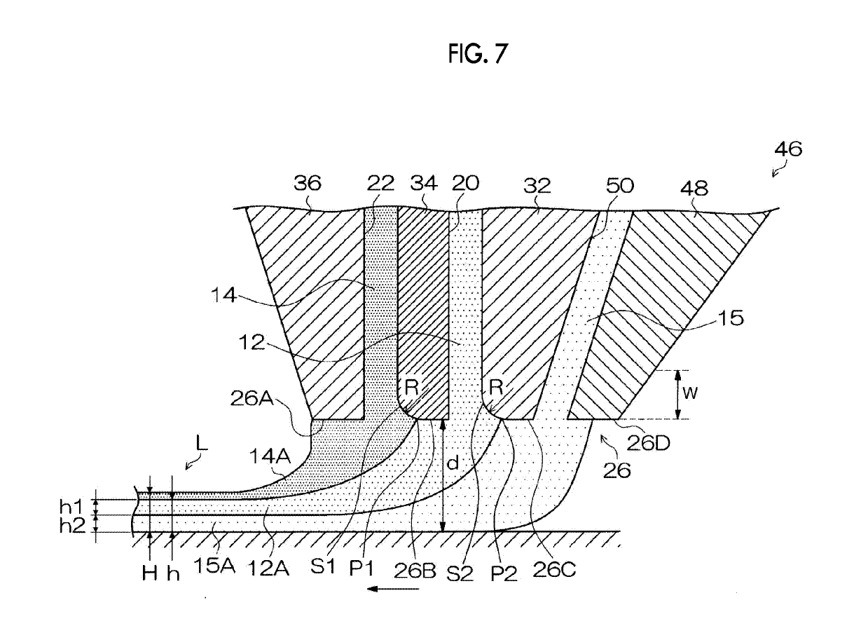

FIG. 7 illustrates a slot die 46 in a case in which three types of coating liquids are coated into multilayers simultaneously. Meanwhile, the same members as in the slot die 28 that coats two layers simultaneously, which is illustrated in FIGS. 1 and 2, are given the same reference sign in description.

As illustrated in FIG. 7, the slot die 46 that coats three layers simultaneously includes four blocks 32, 34, 36 and 48.

Three pockets (not shown) for storing the coating liquids 12, 14 and 15 respectively and the slots 20, 22 and 50 extending to the lip surface 26, which is a tip surface of the slot die 46, from the pockets are formed in the slot die 28 by combining the blocks 32, 34, 36 and 48.

In the lip surface 26, a lip surface on the most downstream side in the transportation direction of the web is called a downstream lip surface 26A, a lip surface adjacent to the downstream lip surface 26A is called a first adjacent lip surface 26B, a next adjacent lip surface is called a second adjacent lip surface 26C, and a lip surface on the most upstream side is called a upstream lip surface 26D. In other words, the tip surface of the block 36 is called the downstream lip surface 26A, the tip surface of the block 34 is called the first adjacent lip surface 26B, the tip surface of the block 32 is called the second adjacent lip surface 26C, and the tip surface of the block 48 is called the upstream lip surface 26D.

In addition, the lip surface end portions S1 and S2 on the downstream side of the first adjacent lip surface 26B and the second adjacent lip surface 26C are formed into a curved shape having a convex cross-sectional direction.

Thereby, even in the case of three-liquid simultaneous multilayer coating, through the same mechanism as described in FIGS. 3 and 5, when a contact line P1 on the first adjacent lip 26B and a contact line P2 on the second adjacent lip 26C move and pass through the lip surface end portions S1 and S2, the contact lines P1 and P2 are not disturbed, and therefore the streak defects do not occur.

In addition, in a case in which a coated film is manufactured using the coating apparatus 10 having the slot die 46 that coats three liquids into multilayers simultaneously, coating is carried out by using the three types of coating liquids 12, 14 and 15 having a viscosity of 0.5 mPa·s to 40 mPa·s, and, so as to satisfy the condition of bridging limit>d≧3 h wherein the distance between the web 16 and the lip surface on the upstream side of the slot 22 located in the most downstream side in the transportation direction of the web 16, that is, the first adjacent lip surface 26B is represented by d, and the wet thickness of the coating liquid 12 that configures the bead portion at a position of the clearance which corresponds to the distance d, among the wet thickness H of the multilayer coating film L is represented by h. In the case of three liquids, h refers to the sum of the wet film thickness h1 of the coating liquid 12 and the wet film thickness h2 of the coating liquid 15 as illustrated in FIG. 7.

Meanwhile, the method of manufacturing a coated film of the embodiment describes an example of the coating conditions of the coating apparatus 10 that coats two liquids and three liquids into multilayers simultaneously, but the coating condition may be generalized as follows. That is, the coating is carried out so as to satisfy the condition of the bridgin limit>d≧3 h wherein d represents the distance between the web and the lip surface with which the interface on the most downstream side comes into contact in among the distances of the clearance between the web and the lip surface with which the interface of the plurality of coating liquids comes into contact, and h represents the wet thickness of the coating liquid that configures the bead portion at the position of the clearance which corresponds to the distance d, among the wet thickness of the multilayer coating film.

### EXAMPLES

Next, specific examples of the coating apparatus and the method of manufacturing a coated film of the claimed invention will be described.

First, two liquids of Coating liquid A and Coating liquid B having a viscosity of 10 mPa·s were coated into multilayers simultaneously on a polyethylene terephthalate (PET) web being transported using the coating apparatus capable of coating two liquids into multilayers simultaneously, which is illustrated in FIG. 1. Then, a bi-layered coating film was dried, thereby manufacturing a coated film.

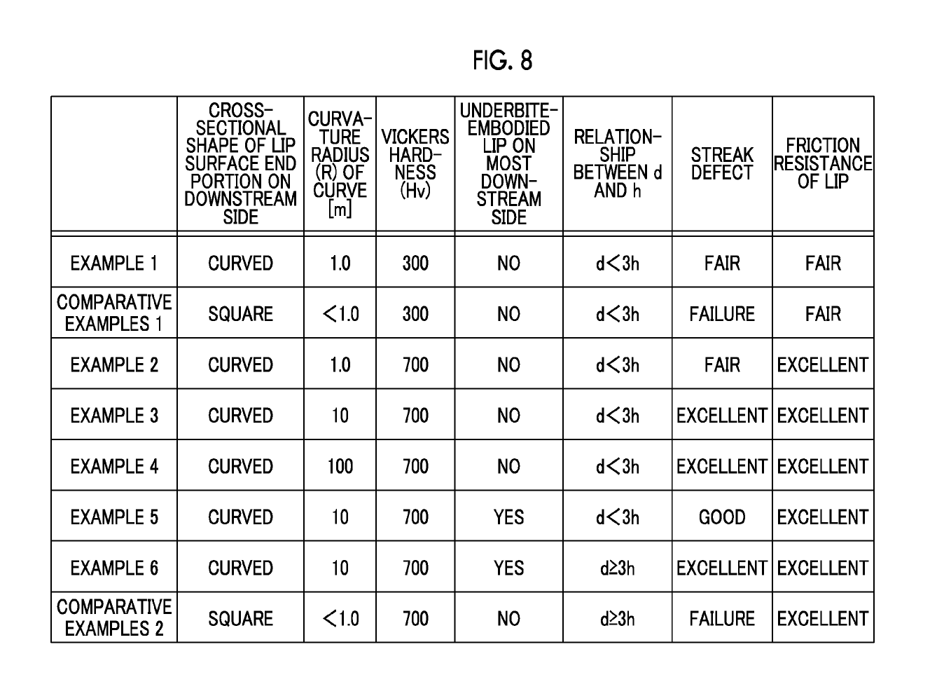

In addition, as described in the table of FIG. 8, “the presence of streak defect” and “the friction resistance of the lip surface” were evaluated using six parameters of “the cross-sectional shape of the lip surface end portion on the downstream side”, “the curvature radius (R) of the curve”, “the Vickers hardness of the lip surface”, “whether the underbite structure is implemented in the lip on the most downstream side” and “the relationship between d and h”. Here, d represents the distance between the adjacent lip surface and the web, and h represents the wet thickness of a coating liquid that configures a bead portion at a position of the clearance which corresponds to the distance d, in the wet thickness H of the multilayer coating film.

Meanwhile, in the table of FIG. 8, the “curvature radius (R) of the curve” of R<1 μm refers to a case in which the lip surface end portion on the downstream side was not intentionally curved through polishing or the like, and the cross-sectional shape of the lip surface end portion was a square shape. In addition, for R=1 μm, R=10 μm and R=100 μm, which are Rs of 1 μm or more, the lip surface end portions on the downstream side were intentionally curved through polishing.

(Evaluation Standards)

For the evaluation of the streak defect, the rear surface of the manufactured coated film was coated to be black, and the reflected light of a fluorescent lamp was visually observed.

“Excellent” indicates that there is no streak defect (including both sharp streaks and broad streaks), “Good” indicates that the slight streak defect were present, but did not cause a problem, “Fair” indicates that the streak defect were present, but were within the allowable limit, and “Failure” indicates that the streak defects occurred beyond the allowable level.

In addition, the testing method and the evaluation method of the friction resistance of the lip are as follows.

(Testing Method)

The lip was slid by a certain distance using a tribometer (S/N: 12-170) manufactured by CSM Instruments SA, and the depths of abrasion scratches were measured. The testing conditions are a disc radius of 3 mm, a velocity of 10.5 cm/second, a load of 7 N and an operation number of 60,000.

(Evaluation Method)

A depth of 100 μm or less: the friction resistance of the lip is excellent.

A depth of 100 μm to 200 μm: the friction resistance of the lip is good.

A depth of 200 μm to 300 μm: the friction resistance of the lip is fair.

A depth of 300 μm or more: the friction resistance of the lip is failure.

(Evaluation Results)

The evaluation results are described in Table 8.

Example 1 is a case in which the coating method conditions were set to obtain d<3 h under the coating apparatus conditions of a cross-sectional shape of the lip surface end portion on the downstream side having R=1 μm, a Vickers hardness of the lip surface of 300 Hv and no underbite structure, was evaluated to be “fair” in terms of the streak defect, and was evaluated to be “fair” in terms of the friction resistance of the lip.

Comparative example 1 had the same conditions as Example 1 except that R<1 μm, and the cross-sectional shape of the lip surface end portion on the downstream side was square, was evaluated to be “failure” in terms of the streak defect, and was evaluated to be “fair” in terms of the friction resistance of the lip.

As is evident from the comparison between Example 1 and Comparative example 1, the occurrence of streak defect can be suppressed by curving the cross-sectional shape of the lip surface end portion on the downstream side even to a slight extent.

Example 2 is a case in which the Vickers hardness of Example 1 was increased from 300 Hv to 700 Hv, and was improved from “fair” to “excellent” in terms of the friction resistance of the lip.

Example 3 is a case in which the cross-sectional shape of the lip surface end portion on the downstream side in Example 2 was increased from R=1 μm to R=10 μm, and was improved from “fair” to “excellent” in terms of the streak defect.

Example 4 is a case in which the cross-sectional shape of the lip surface end portion on the downstream side in Example 2 was increased from R=1 μm to R=100 μm, and was improved from “fair” to “excellent” in terms of the streak defect.

Example 5 is a case in which the under-bite structure was provided in Example 2, and was evaluated to be “good” in terms of the streak defect. In a case in which Example 5 and Example 3 are compared, there is a difference in the presence or absence of the underbite structure, and it is found that the streak defect is more likely to occur in a coating apparatus having the under-bite structure. However, it is found that, even in a case in which the underbite structure was applied, it is possible to make the coating apparatus evaluated to be “good” in terms of the streak defects by implementing the claimed invention.

Example 6 is an example in which the underbite structure was applied, d≧3 h was set, and the clearance d was increased to be three times or more as large as the film thickness h in Example 2, and produced a favorable result of being “excellent” in terms of the streak defect.

Comparative example 2 is a case in which R=10 μm in Example 6 was changed to R>1 μm, and the cross-sectional shape of the lip surface end portion on the downstream side was changed from being curved to being square, and produced a poor result of being “failure” in terms of the streak defect.

It is also found from the comparison between Example 6 and Comparative example 2 that the occurrence of streak defect can be significantly suppressed by curving the cross-sectional shape of the lip end portion on the downstream side.

What is claimed is:

1. A coating apparatus comprising:
a backup roller configured to support a web being transported;
a slot die disposed opposite to the backup roller, the slot die including a plurality of slots and being configured to eject a plurality of coating liquids from tips of the plurality of slots respectively so as to form beads of the coating liquids in a clearance between the web and a lip surface, which is a tip surface of the slot die, thereby coating the plurality of the coating liquids into multilayers simultaneously on the web being transported; and
a depressurizing apparatus configured to depressurize an upstream side of the beads of the coating liquids in a transportation direction of the web,
wherein, among the lip surfaces which sandwich the plurality of slots therebetween, a lip surface end portion on a downstream side in a transportation direction of the web of the lip surface with which an interface of the plurality of the coating liquids comes into contact has a curved shape with a convex cross-sectional shape.

2. The coating apparatus according to claim 1,
wherein at least a portion of the lip surface of the slot die have a Vickers hardness (Hv) of 500 or more, and only the lip surface end portion on the downstream side in the transportation of the web of the lip surface with which the interface of the plurality of coating liquids comes into contact have the curved shape with the convex cross-sectional shape.

3. The coating apparatus according to claim 1,
wherein the curved shape is an arc shape having a curvature radius of 1 μm or more.

4. The coating apparatus according to claim 2,
wherein the curved shape is an arc shape having a curvature radius of 1 μm or more.

5. The coating apparatuses according to claim 1,
wherein the slot die has an underbite structure, in which a distance between the web and the lip surface located on a most downstream side in the transportation direction of the web is longer than a distance between the web and other lip surfaces.

6. The coating apparatuses according to claim 2,
wherein the slot die has an underbite structure, in which a distance between the web and the lip surface located on a most downstream side in the transportation direction of the web is longer than a distance between the web and other lip surfaces.

7. The coating apparatuses according to claim 3,
wherein the slot die has an underbite structure, in which a distance between the web and the lip surface located on a most downstream side in the transportation direction of the web is longer than a distance between the web and other lip surfaces.

8. The coating apparatuses according to claim 4,
wherein the slot die has an underbite structure, in which a distance between the web and the lip surface located on a most downstream side in the transportation direction of the web is longer than a distance between the web and other lip surfaces.

9. A method of manufacturing a coated film comprising:
a coating step of coating a plurality of coating liquids having a viscosity of 0.5 mPa·s to 40 mPa·s into multilayers simultaneously on a web using the coating apparatus according to claim 1; and
a drying step of drying the multilayer coating film,
wherein, the plurality of coating liquids is coated in the coating step so as to satisfy a condition of bridging limit>d≧3 h, wherein d represents a distance of the clearance between the web and a lip surface with which the interface of the plurality of coating liquids on a most downstream side comes into contact among the clearances between the web and the lip surfaces with which the interface of the plurality of coating liquids comes into contact, and h represents a wet thickness of the coating liquid which constitutes a bead at a position of the clearance corresponding to the distance d, among the wet thickness of the multilayer coating film.

10. A method of manufacturing a coated film comprising:
a coating step of coating a plurality of coating liquids having a viscosity of 0.5 mPa·s to 40 mPa·s into multilayers simultaneously on a web using the coating apparatus according to claim 2; and
a drying step of drying the multilayer coating film,
wherein, the plurality of coating liquids is coated in the coating step so as to satisfy a condition of bridging limit>d≧3 h, wherein d represents a distance of the clearance between the web and a lip surface with which the interface of the plurality of coating liquids on a most downstream side comes into contact among the clearances between the web and the lip surfaces with which the interface of the plurality of coating liquids comes into contact, and h represents a wet thickness of the coating liquid which constitutes a bead at a position of the clearance corresponding to the distance d, among the wet thickness of the multilayer coating film

11. A method of manufacturing a coated film comprising:
a coating step of coating a plurality of coating liquids having a viscosity of 0.5 mPa·s to 40 mPa·s into multilayers simultaneously on a web using the coating apparatus according to claim 3; and
a drying step of drying the multilayer coating film,
wherein, the plurality of coating liquids is coated in the coating step so as to satisfy a condition of bridging limit >d 3h, wherein d represents a distance of the clearance between the web and a lip surface with which the interface of the plurality of coating liquids on a most downstream side comes into contact among the clearances between the web and the lip surfaces with which the interface of the plurality of coating liquids comes into contact, and h represents a wet thickness of the coating liquid which constitutes a bead at a position of the clearance corresponding to the distance d, among the wet thickness of the multilayer coating film.

12. A method of manufacturing a coated film comprising:
a coating step of coating a plurality of coating liquids having a viscosity of 0.5 mPa·s to 40 mPa·s into multilayers simultaneously on a web using the coating apparatus according to claim 4; and
a drying step of drying the multilayer coating film,
wherein, the plurality of coating liquids is coated in the coating step so as to satisfy a condition of bridging limit>d≧3 h, wherein d represents a distance of the clearance between the web and a lip surface with which the interface of the plurality of coating liquids on a most downstream side comes into contact among the clearances between the web and the lip surfaces with which the interface of the plurality of coating liquids comes into contact, and h represents a wet thickness of the coating liquid which constitutes a bead at a position of the clearance corresponding to the distance d, among the wet thickness of the multilayer coating film.

13. A method of manufacturing a coated film comprising:
a coating step of coating a plurality of coating liquids having a viscosity of 0.5 mPa·s to 40 mPa·s into multilayers simultaneously on a web using the coating apparatus according to claim 5; and
a drying step of drying the multilayer coating film,
wherein, the plurality of coating liquids is coated in the coating step so as to satisfy a condition of bridging limit>d≧3 h, wherein d represents a distance of the clearance between the web and a lip surface with which the interface of the plurality of coating liquids on a most downstream side comes into contact among the clearances between the web and the lip surfaces with which the interface of the plurality of coating liquids comes into contact, and h represents a wet thickness of the coating liquid which constitutes a bead at a position of the clearance corresponding to the distance d, among the wet thickness of the multilayer coating film.

14. A method of manufacturing a coated film comprising:
a coating step of coating a plurality of coating liquids having a viscosity of 0.5 mPa·s to 40 mPa·s into multilayers simultaneously on a web using the coating apparatus according to claim 6; and
a drying step of drying the multilayer coating film,
wherein, the plurality of coating liquids is coated in the coating step so as to satisfy a condition of bridging limit>d≧3 h, wherein d represents a distance of the clearance between the web and a lip surface with which the interface of the plurality of coating liquids on a most downstream side comes into contact among the clearances between the web and the lip surfaces with which the interface of the plurality of coating liquids comes into contact, and h represents a wet thickness of the coating liquid which constitutes a bead at a position of the clearance corresponding to the distance d, among the wet thickness of the multilayer coating film.

15. A method of manufacturing a coated film comprising:
a coating step of coating a plurality of coating liquids having a viscosity of 0.5 mPa·s to 40 mPa·s into multilayers simultaneously on a web using the coating apparatus according to claim 7; and
a drying step of drying the multilayer coating film,
wherein, the plurality of coating liquids is coated in the coating step so as to satisfy a condition of bridging limit>d≧3 h, wherein d represents a distance of the clearance between the web and a lip surface with which the interface of the plurality of coating liquids on a most downstream side comes into contact among the clearances between the web and the lip surfaces with which the interface of the plurality of coating liquids comes into contact, and h represents a wet thickness of the coating liquid which constitutes a bead at a position of the clearance corresponding to the distance d, among the wet thickness of the multilayer coating film.

16. A method of manufacturing a coated film comprising:
a coating step of coating a plurality of coating liquids having a viscosity of 0.5 mPa·s to 40 mPa·s into multilayers simultaneously on a web using the coating apparatus according to claim 8; and
a drying step of drying the multilayer coating film,
wherein, the plurality of coating liquids is coated in the coating step so as to satisfy a condition of bridging limit>d≧3 h, wherein d represents a distance of the clearance between the web and a lip surface with which the interface of the plurality of coating liquids on a most downstream side comes into contact among the clearances between the web and the lip surfaces with which the interface of the plurality of coating liquids comes into contact, and h represents a wet thickness of the coating liquid which constitutes a bead at a position of the clearance corresponding to the distance d, among the wet thickness of the multilayer coating film.

17. The method of manufacturing a coated film according to claim 9, further comprising:
a die preparation step of, prior to the coating step, preparing a slot die having the lip surface, which is a tip surface of the slot die, formed of a material having a Vickers hardness (Hv) of 500 or more and a lip surface end portion on a downstream side of the lip surface with which an interface of a plurality of the coating liquids comes into contact, in a transportation direction of the web polished into a curved shape with a convex cross-sectional shape.

18. The method of manufacturing a coated film according to claim 17,
wherein, in the die preparation step, the lip surface is polished so that a curvature radius of the lip surface end portion is 1 μm or more.

19. The method of manufacturing a coated film according to claim 18,
wherein, in the die preparation step, only the lip surface with which the interface of the plurality of coating liquids comes into contact is polished.
